(19) United States
(12) Patent Application Publication
(10) Pub. No.: US 2005/0004826 A1
(43) Pub. Date: Jan. 6, 2005

(54) Method for updating the supply plan used by an available-to-promise system

(75) Inventors: Christine Chen, San Mateo, CA (US); Nagaraj Srinivasan, Fremont, CA (US); Nadeem Syed, Redwood Shores, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: ORACLE INTERNATIONAL CORPORATION, a California corporation, Redwood Shores, CA (US)

(21) Appl. No.: 10/612,257

(22) Filed: Jul. 1, 2003

(51) Int. Cl. G06F 17/60

(52) U.S. Cl. 705/8

(57) ABSTRACT

A method of updating a supply plan used to process customer requests in an available-to-promise (ATP) system. In one embodiment the method comprises updating a model of a supply chain process for one or more products sold by the ATP system and copying a current supply plan used by the ATP system to process customer requests to create a second supply plan. Thereafter, a first plurality of customer requests is received and orders from the requests are processed by the ATP system against the current supply plan while running the updated model of the supply chain process with the second supply plan as part of a process that creates a new supply plan. After the new supply plan is created, the new supply plan is synchronized with the old supply plan by synchronizing orders from the first plurality of customer requests scheduled against the old supply plan into the new plan while order promising continues against the old plan. The synchronizing process is stopped prior to synchronizing every one of the orders in the first plurality of requests into the new supply plan. Thereafter, all remaining orders from the first plurality of requests not synchronized during the synchronizing process are synchronized into the new supply plan while the ATM system temporarily stops promising orders. After the remaining orders from the first plurality of requests are synchronized, old supply plan is replaced by the new supply plan so that the ATP system processes future customer requests against the new supply plan.

### BACKGROUND OF THE INVENTION

The invention relates to a system and method for promising sales orders based on product supply. Specific embodiments of the invention relate to a system and method for managing available-to-promise orders in order to fulfill customer requests.

The ability to quickly and accurately promise orders is important in order for product manufacturers and distributors to retain existing customers and attract new customers. To achieve this goal, a number of systems have been developed that allow manufacturers and distributors to accept customer requests and generate promises to fulfill such requests 24 hours a day, seven days a week. These systems generally promise order fulfillment using what the industry refers to as a “supply plan.”

A supply plan combines current product supply and projections of customer demand with supply-side constraints (for example, material requirements, capacity requirements and product manufacturing and assembly times). Systems that use supply plans to fulfill customer requests are often referred to as available-to-promise (ATP) systems where available-to-promise refers to the ability to promise product availability based on a pre defined statement of current and planned supply and capacity (the supply plan). Using a supply plan, ATP systems are able to associate product quantities with the dates such products are scheduled to be available for shipment. ATP systems use this information to promise delivery of the products to customers by specific dates.

The accuracy of ATP systems is only as good as the supply plan the system relies upon to determine dates that products will be available for shipment (i.e., the date an order for those products is promised to be fulfilled). Accordingly, it is important to update the plan on a regular basis to take into account changes in the supply side of the plan since the plan was created. Such changes may include, for example, increased or decreased factory output, changes in the availability of raw materials, changes related to shipping times and/or constraints.

ATP systems typically define the supply plan using one or more database tables. In one ATP system known to the inventors, updating the supply plan used by the system is done by invalidating entries in the system's database tables that will be replaced by new entries at the end of the demand plan update process. During this time the system lacks data (or contains incomplete or inaccurate data) required to process ATP enquiries. Thus, the ATP system is generally not available to process orders during the supply plan update process. Complexities associated with changing the ATP system from an outdated supply plan to a newer supply plan often take several hours or longer. Thus, ATP systems are often unavailable for order promising for several hours or longer while the supply plan associated with the system is updated.

Accordingly, improved systems and methods for updating supply plans in ATP systems are desirable.

### BRIEF SUMMARY OF THE INVENTION

Embodiments of the invention allow the supply plan used by an ATP system to be updated while minimizing the time the system is taken offline. The updates are made in a manner that allows requests taken during the update process to be promised based on the new plan. Embodiments of the invention allow for very close to 24×7 order promising and allow for such order promising to be performed as accurately as the supply plans allows.

According to one embodiment of the invention, a method of updating a supply plan used to process customer requests in an available-to-promise (ATP) system comprises updating a model of a supply chain process for one or more products sold by the ATP system and copying an old supply plan used by the ATP system to process customer requests to create a second supply plan. Thereafter, a first plurality of customer requests are received and orders from the requests are processed by the ATP system against the old supply plan while the updated model of the supply chain process is run with the second supply plan as part of a process that creates a new supply plan. After the new supply plan is created, the new supply plan is synchronized with the old supply plan by synchronizing orders from the first plurality of customer requests scheduled against the old supply plan into the new plan while order promising continues against the old plan. The synchronizing process is stopped prior to synchronizing all the orders in the first plurality of requests into the new supply plan. Thereafter, all remaining orders from the first plurality of requests not synchronized during the synchronizing process are synchronized into the new supply plan while the ATP system temporarily stops promising orders. After the remaining orders from the first plurality of requests are synchronized, old supply plan is replaced by the new supply plan so that the ATP system processes future customer requests against the new supply plan.

A method of managing available-to-promise sales orders is also disclosed. In one embodiment the method comprises receiving a first plurality of requests from customers and promising orders from the first plurality of requests against a first supply plan; creating a new supply plan; receiving a second plurality of requests from customers while the new supply plan is being created, wherein the second plurality of requests is received after the first plurality of requests; promising orders from the second plurality of requests against the first supply plan; invalidating the first supply plan and activating the new supply plan; receiving a third plurality of requests from customers, wherein the third plurality of requests is received after the second plurality of requests; and promising orders from the third plurality of requests against the new supply plan.

One embodiment of an available-to-promise (ATP) system for processing customer requests according to the invention comprises a supply chain planning component configured to allow a planner to update a model of a supply chain for one or more products sold by the ATP system and an order promising component configured to allow a planner to update an old supply plan used to process requests with a new supply plan. The order promising component is capable of (i) copying a current supply plan used by the ATP system to process customer requests to create a second supply plan; (ii) thereafter, receiving a first plurality of customer requests at the ATP system and processing orders from the first plurality of requests against the current supply plan while the ATP system runs the model of the supply chain process with the second supply plan as part of a process that creates a new supply plan; (iii) after the new supply plan is created, synchronizing orders from the first plurality of customer requests scheduled against the current supply plan into the new supply plan until a threshold number of orders in the first plurality of requests is reached; (iv) thereafter, temporarily stopping promising new customer requests received by the ATP while checking all remaining orders from the first plurality of requests not checked during the synchronizing process against the new supply plan; and (v) after the remaining orders from the first plurality of requests are processed, switching the new plan supply for the current supply plan so that the ATP system can process future customer requests against the new supply plan.

These and other embodiments of the invention along with many of its advantages and features are described in more detail in conjunction with the text below and attached figures.

### BRIEF DESCRIPTION OF THE DRAWINGS

FIG. 1 is a block diagram of an available-to-promise ordering system according to one embodiment of the present invention;

FIG. 2 is a flowchart illustrating the steps according to one embodiment of the present invention associated with updating the supply plan used by system 10 shown in FIG. 1; and

FIG. 3 is a timeline illustrating events associated with the steps discussed in the flowchart of FIG. 2.

### DETAILED DESCRIPTION OF THE INVENTION

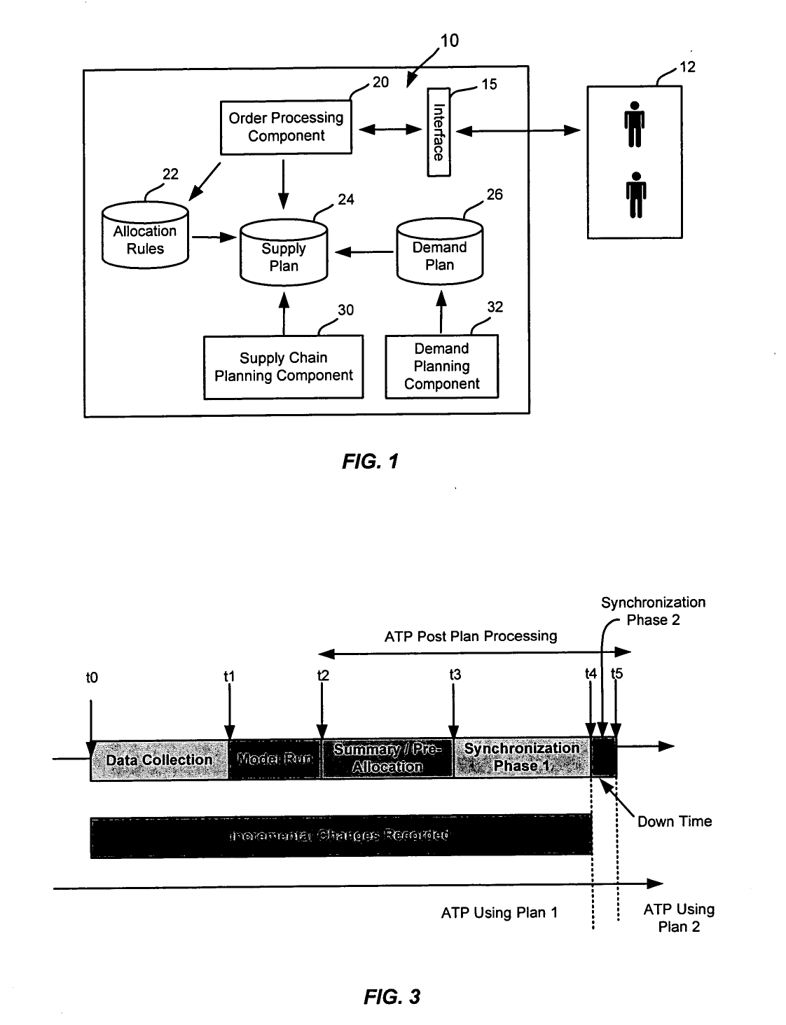

FIG. 1 is a block diagram of an available-to-promise (ATP) ordering system 10 according to one embodiment of the present invention. ATP System 10 is programmed to enable sophisticated, fast, accurate and flexible order promising for an organization. System 10 includes an order promising component 20 that receives, processes and responds to requests received from customers 12, such as requests to purchase one or more products. Responses to the requests are in the form of a promised delivery date for the one or more products. As used herein, each customer request may include one or more orders. For example, a customer may place a request with system 10 for 20 units of Product A to be received by Date 1, 50 units of Product A to be received by Date 2 and 10 units of Product C to be received by Date 3. Each of these individual requests within the customer request is referred to herein as an order. System 10 is programmed to be able to fulfill (promise) orders within a request independent of other orders in the request.

In processing customer requests, order processing component 20 reserves available inventory (or inventory that will be available in the future) for the customer from one or more warehouses best suited to ship the products to the customer or, if the products are not currently in inventory, from one or more manufacturing facilities best suited to complete the products. Requests from the customer are typically made with a client system (not shown) that accesses system 10 through an interface 15. The client system may be, for example, a personal computer.

In one embodiment, order processing component 20 is part of a distributed computing system and multiple client systems communicate with order processing component 20 via the Internet. Accordingly, in some embodiments of the invention, order processing component 20 provides support for handling multiple concurrent order promising requests by implementing locking and read consistency of data so that the same supply is not promised to multiple customers.

In one embodiment, interface 15 is in the form of web pages that present information necessary to order products from system 10 to the client system. The web pages accept input from the customer related to requests for one or more products and translate the requests into a format that can be acted upon by order processing component 20.

Order processing component 20 makes decisions related to fulfilling orders generated from the requests based on pre-defined allocation rules 22 and a supply plan 24. Allocation rules 22 are created by an organization to define how its supply of products (and planned supply of products) is allocated to fulfill customer requests in accordance with the organization's business goals. For example, allocation rules 22 can be developed to allocate and reserve percentages of products to preferred customers, allocate and reserve a percentage of products to new customers, and the like.

Supply plan 24 is a pre-defined statement of current and planned supply. Supply plan 24 is created by an organization to address all aspects of the supply chain including resource and materials allocation, resource and materials constraints, item substitution and others. In some embodiments system 10 allows for collaboration with suppliers and supply plan 24 addresses supplier constraints and supplier schedules. In one embodiment, supply plan 24 also addresses multi-level component and/or resource availability checking. These features enable order processing component 20 to perform capable-to-promise and capable-to-deliver processing where capable-to-promise refers to the additional ability to determine the availability of component materials and resources to meet unplanned demands and capable-to-deliver refers to considering the transit lead time to meet the customer's delivery needs.

Supply plan 24 can be created in conjunction with a demand plan 26. In one embodiment the supply plan is created with tools provided by a supply chain planning component 30 and the demand plan is created with tools provided by a demand planning component 32. Demand plan 26 allows an organization to produce unconstrained forecasts for future demand and generate tactical, operational and strategic business plans. The demand plan can be used by the organization associated with system 10 to drive the supply chain process. That is, once the organization predicts future demand, supply chain planning component 32 can be used to help the organization develop a supply plan 24 that will meet the demand predicted in demand plan 26.

Thus, as can be appreciated by a person of skill in the art, supply plan 24 is an important part of system 10 for enabling order promising component 20 to accurately fulfill customer requests. That is, system 10 needs access to supply plan 24 on a 24 hour a day, seven day a week basis in order to respond to customer requests in real time with promises of future delivery dates. Because the accuracy of promises made by system 10 is directly related to the accuracy of supply plan 10, it can be appreciated that it is important to update supply plan 24 on a regular basis.

Updating supply plan 24 typically includes updating, adding and/or deleting the supply information used by the organization to model its supply chain for the product(s) offered by the organization. Thus, updating supply plan 24 entails first updating the model that defines for resource and materials requirements, resource and materials allocation, resource and materials constraints, sourcing strategies, etc. After the model is updated, the model is run on real data from the current, and soon to be old, supply plan 24 to produce a new supply plan 24. As previously mentioned, the process of running the model on real data may take several hours or longer, which in some previously known ATP systems resulted in the systems being unable to process customer requests during the entire lengthy supply plan update process.

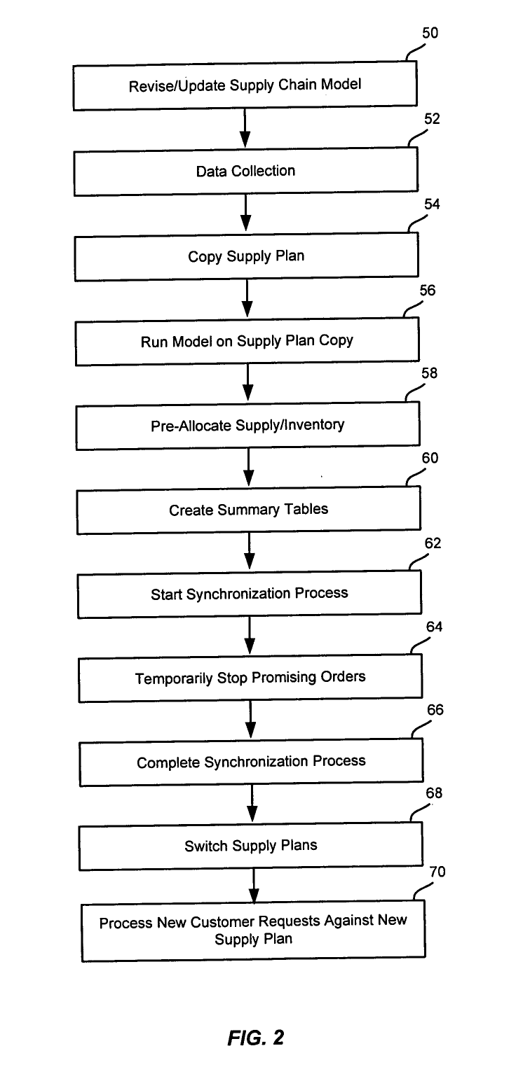

The present inventors have developed a method of swapping a new supply plan 24 in system 10 for an old supply plan 24 in a manner that minimizes the time during which order processing component 20 is unable to accurately process customer requests. One embodiment of the method of the present invention is discussed below in conjunction with FIGS. 2 and 3. FIG. 2 is a flowchart of one embodiment of the method of the invention and FIG. 3 is a timeline depicting the sequence of some of the events set forth in the flowchart of FIG. 2. It is to be understood that some of the steps shown in FIG. 2 are optional and other embodiments of the invention may include more or fewer steps.

As shown in FIG. 2, the method starts with a planner (e.g., an employee or consultant of the organization selling products with system 10) updating the model of the organization's supply chain for one or more products obtainable through by system 10 (step 50). The supply chain model can be used by system 10 to create a specific supply plan 24. In some embodiments the supply chain model is based in part on demand predicted by demand plan 26. Thus, in some embodiments, updating the supply chain model in step 50 includes updating the demand plan 26. The supply chain model and demand plan 26 can be updated using supply chain planning component 30 and demand planning component 32, respectively.

Once the supply chain model has been updated to reflect all desired changes that are to be taken into consideration in the creation of the new supply plan, a snapshot of data representing actual sales and order demand at a time to is captured (FIG. 2, step 52). Examples of the data that is collected may include demand information, supply schedules, sourcing rules, resource information and resource capacity among other data. This data will be used by the updated model to create a new supply plan 24. Because the new supply plan has to be created from a data set of ATP orders and the supply state that existed at a previous time, any changes to the supply state (e.g., customer orders fulfilled or promised by ATP system 10) after the snapshot of the data is taken in step 52 will not be considered during creation of the new supply plan. Thus, all records inserted by the ATP system that pertain to the supply state after time to have to be processed against the new supply plan after it has been created by running the model. As shown in FIG. 3, the data collection period lasts from time t₀ to time t₁.

After the data collection period is over, the updated model is launched (run) and a copy of the current supply plan 24 is made (step 54). In one embodiment, running the model automatically copies the current supply plan. For convenience, in the following discussion the current supply plan that was copied is referred to as “Plan 1” and the copy of the current supply plan is referred to as “Plan 2.” All further ATP requests at this point are made against Plan 1 and the supply chain model is run on Plan 2 in order to create the new supply plan 24 (step 56). As shown in FIG. 3, the model runs from time t₁ to time t₂.

At the completion of the model run, new supply plan 24 is created. Some embodiments of the invention include a database entry associated with each supply plan that indicates to order promising component 20 whether or not the supply plan is to be used in fulfilling customer requests. In such embodiments, the new supply plan is not yet marked active at this point and orders are still processed against Plan 1.

Next, a pre-allocation program is run that pre-allocates supply to specific classes of demand (step 58) and a summary program is run that stores summary supply and demand information from the new supply plan in a separate table (step 60). The separate summary table is used by order promising component 20 whenever possible to quickly retrieve summarized availability information without computing availability from more detailed supply and demand tables. The pre-allocation program uses allocation rules 22 to pre-allocate selected volume or percentages of products and/or supply in accordance with the business objectives of the organization. As shown in FIG. 3, the summary and pre-allocation programs run from time t₂ to time t₃.

Next, a synchronization program is run to begin the process that will synchronize customer orders processed since time to and promised against Plan 1 to be checked against the new supply plan (step 62). The synchronization process will synchronize most, but not all of the customer orders processed after time t₀. In one embodiment the synchronization process will process all but n orders taken after time t₀. The number of orders (n) not checked against the new supply plan can be set by the planner. In another embodiment the planner selects an amount of time (e.g., 10 minutes) to process the orders not checked against the new supply plan by the synchronization program and the synchronization program automatically determines, based on the average time it takes the program to process each order, the number of orders that can be processed in the selected time period. The program then selects some number less that and processes all orders taken after time t₀ up to that number. The selected time represents the amount of time that customer requests cannot be processed by system 10 during step 62 described below.

As an example, if a planner selects a 10 minute time period for step 62 and synchronization program takes an average of 6 seconds to process an order, the program will calculate 100 orders as the number that can be processed in the 10 minute period. Assuming the planner decides that the half the calculated number should be used as n, the program will then stop synchronizing messages against the new supply plan when there are 50 orders that still need to be checked against the new supply plan.

As can be appreciated from the above, the synchronization program needs to be able to track which orders were received and processed after time t₀. In one embodiment this is done by tracking a refresh number that increases sequentially in time. A new refresh number is assigned for each request and a refresh number is assigned to the start of the data collection in FIG. 2. Multiple orders within a single request receive the same refresh number. Using this technique, system 10 can quickly tell if an individual order was processed before or after the data collection step by comparing the refresh number of the order with the refresh number of the event. This technique can also be used to allow system to calculate how many orders have been processed since the data collection step or any other given event that has a refresh number associated with it.

The synchronization process also needs to distinguish between records that have been synchronized and records that still need to be. One embodiment of the invention keeps track of this information with a flag that is set whenever a record is synchronized against the data in the new supply plan. Thus, in this embodiment, only those records that have a refresh number greater than the one associated with time t₀ and have their synchronization flag not set will be considered for synchronization. A person of skill in the art will appreciate many different techniques that can be used to track whether orders were promised before or after the start of the supply plan updating process and whether any such orders have already been synchronized.

After the first portion (step 62) of the synchronization process has been completed, system 10 stops promising products for customer requests (step 64) for a brief period while the remaining orders that have not yet been checked against the new supply plan 24 are processed against the new plan (step 66). The orders checked against the new plan during step 66 also include orders from requests received, processed and promised during the time t₃ to t₄ (FIG. 3) when the synchronization program is running. In one embodiment, when system 10 receives requests for products from customers during step 64/66, error messages are generated by the system and delivered to the customer indicating the system is currently unavailable. In another embodiment, system 10 estimates how much longer order processing will be unavailable based on the number of messages that need to be synchronized and generates and sends a message to the customer indicating that real time order fulfillment is temporarily not available but should be available in x minutes.

There may be instances where the synchronization process of steps 60 and 64 determines orders promised versus the old plan cannot be kept based on the new plan. In such instances where an already scheduled delivery date cannot be met with the new plan, an exception is raised and a message indicating such is available for the planner to review. In some embodiments a message to the planner is automatically generated and sent in response to such an exception.

In one embodiment the synchronization process only checks to see if a given order can be met under the new supply plan on the date the order was previously scheduled for under the old plan. It will not advance the delivery date, nor will it postpone the scheduled date. It will, however, reserve materials and capacities required to fulfill this order. The check is done with a flag that allows for overriding the ATP system decision being set. Thus, the sales order will be scheduled for the old delivery date even if it cannot be met on that date. In such a situation the planner is responsible for viewing these exception messages and taking further action as suitable.

After the remaining orders have been processed, the supply plan for order promising component 20 is switched from the old supply plan to the new supply plan (step 68) and customer requests are processed against the new supply plan (step 70). In one embodiment plan switching is accomplished by changing a pointer to the new supply plan and setting a flag associated with the new supply plan to indicate that the new supply plan is available for ATP processing.

Having fully described several embodiments of the present invention, other equivalent or alternative methods of practicing the present invention will be apparent to those skilled in the art. For example, while system 10 was described as including allocation rules 22, such rules are optional. In some embodiments of the invention order processing component 20 fulfills orders based on a supply plan 24 without checking allocation rules. Also, in another embodiment where allocation rules 22 are used, system 10 includes and allocated supply plan (not shown) that is used by order processing component 22 to fulfill orders instead of supply plan 24. The allocated supply plan is created from a combination of the allocation rules 22 and supply plan 24 and saved separate from each. Also, in other embodiments, the creation of a summary table in step 60 is optional.

As another example, while system 10 was described as a distributed system, the system may be deployed in various other environments such as an enterprise environment, a stand-alone system, and the like. Also, while the present invention has been described using a particular combination of hardware and software, it should be recognized that other combinations of hardware and software are also within the scope of the invention. Specifically, the invention may be implemented primarily in hardware, primarily in software, or using appropriate combinations thereof. These and other embodiments as well as alternatives and equivalents to the invention will be recognizable to those of skill in the art after reading the description of the present invention. The scope of the invention should not, therefore, be determined solely by reference to the above description, but instead should be determined with reference to the appended claims along with their full scope of equivalents and alternatives.

1. A method of updating a supply plan used to process customer requests in an available-to-promise (ATP) system, the method comprising: updating a model of a supply chain for one or more products sold by the ATP system; copying a current supply plan used by the ATP system to process customer requests to create a second supply plan; thereafter, receiving a first plurality of customer requests at the ATP system and processing orders from the requests against the current supply plan while running the model of the supply chain process with the second supply plan as part of a process that creates a new supply plan;
after the new supply plan is created, synchronizing the new supply plan with the current supply plan by synchronizing orders from the first plurality of customer requests scheduled against the current supply plan into the new supply plan, wherein the synchronizing process is stopped prior to synchronizing all the orders in the first plurality of requests into the new supply plan; thereafter, temporarily stopping promising orders while synchronizing all remaining orders from the first plurality of requests not synchronized during the synchronizing process into the new supply plan; and after the remaining orders from the first plurality of requests are processed, replacing the current supply plan with the new supply plan so that the ATP system processes future customer requests against the new supply plan.

2. The method of claim 1 wherein the step of switching the old supply plan to the new supply plan is performed by changing a pointer to the new supply plan and setting a flag associated with the new supply plan to indicate that the new supply plan is available for ATP processing.

3. The method of claim 1 wherein an exception is generated if a promise made against the old supply plan cannot be made against the new supply plan.

4. The method of claim 3 wherein the exception causes a message to be generated and available to a planner for processing.

5. The method of claim 3 wherein the exception causes a message to be sent to a planner for processing.

6. The method of claim 1 wherein the step of synchronizing the new supply plan the old supply plan comprises stopping synchronization when it is determined that a predetermined number of requests still need to be synchronized.

7. The method of claim 6 wherein the predetermined number is calculated by system 10 based on an average time of synchronizing each request and a desired system downtime entered by a planner.

8. The method of claim 1 further comprising, prior to running the model, capturing a snapshot of data representing actual sales and promised requests for use in creation of the new supply plan.

9. The method of claim 1 further comprising creating a summary table from the new supply plan that can be used by the ATP system to quickly retrieve summarized availability information without computing availability from more detailed supply and demand tables.

10. The method of claim 1 further comprising pre-allocating products available for promising in the new supply plan in accordance with previously defined business objectives of an organization.

11. The method of claim 1 further comprising, after switching to the new supply plan, receiving a second plurality of customer requests by the ATP system and promising orders from the second plurality of requests against the new supply plan.

12. The method of claim 1 wherein the synchronizing process is stopped when a number of outstanding orders not synchronized into the new plan reaches a threshold.

13. The method of claim 12 wherein the threshold is a user-defined threshold.

14. A method of managing available-to-promise sales orders, the method comprising: receiving a first plurality of requests from customers and promising orders from the first plurality of requests against a first supply plan; creating a new supply plan; receiving a second plurality of requests from customers while the new supply plan is being created, wherein the second plurality of requests is received after the first plurality of requests; promising orders from the second plurality of requests against the first supply plan; invalidating the first supply plan and activating the new supply plan; receiving a third plurality of requests from customers, wherein the third plurality of requests is received after the second plurality of requests; and promising orders from the third plurality of requests against the new supply plan.

15. The method of claim 14 further comprising copying the old supply plan and creating the new supply plan from the copy of the old supply plan.

16. An available-to-promise (ATP) system for processing customer requests, the system comprising: a supply chain planning component configured to allow a planner to update a model of a supply chain for one or more products sold by the ATP system; an order promising component configured to allow a planner to update an old supply plan used to process requests with a new supply plan by (i) copying a current supply plan used by the ATP system to process customer requests to create a second supply plan; (ii) thereafter, receiving a first plurality of customer requests at the ATP system and promising orders from the first plurality of requests against the current supply plan while the ATP system runs the model of the supply chain process with the second supply plan as part of a process that creates a new supply plan; (iii) after the new supply plan is created, synchronizing orders from the first plurality of customer requests scheduled against the current supply plan into the new supply plan until a threshold number of orders in the first plurality of requests is reached; (iv) thereafter, temporarily stopping promising orders from new customer requests received at the ATP system while checking all remaining orders from the first plurality of requests not checked during the synchronizing process against the new supply plan; and (v) after the remaining orders from the first plurality of requests are processed, switching the new plan supply for the current supply plan so that the ATP system can process future customer requests against the new supply plan.

17. The system of claim 16 further comprising a demand planning component configured to allow a planner to create a demand plan that can be used by the supply chain planning component to model a supply chain.

18. The system of claim 16 wherein the threshold number is a user-defined limit.
